(19) United States
(12) Patent Application Publication
(10) Pub. No.: US 2004/0205658 A1
(43) Pub. Date: Oct. 14, 2004

(54) Data processor controlled interactive document editing display system with an implementation for swapping the positions of tow designated segments of data in a displayed document

(75) Inventors: David Raymond Posh, Cedar Park, TX (US); Kurt Russell Taylor, Austin, TX (US)

Correspondence Address: Leslie A. Van Leeuwen, IBM, Corp., Intellectual Property Law Dept., Internal Zip 4054, 11400 Burnet Road, Austin, TX, 78758, US

(73) Assignee: International Business Machines Corporation, Armonk, NY

(21) Appl. No.: 10/082,745

(22) Filed: Feb. 21, 2002

(51) Int. Cl. G06F 17/21; G06F 17/24; G06F 17/00; G06F 15/00

(52) U.S. Cl. 715/530; 715/531

(57) ABSTRACT

A user friendly display interface that expedites the switching of positions of a pair of sections with each other in a displayed word processing document. The invention involves an implementation for defining one segment of displayed data in a displayed document together with defining another segment of displayed data in the displayed document, and a function enabling a user to select to swap said one segment with said another segment. There is a function responsive to such a user selection to swap for swapping the positions of the defined segments of data with each other. As an interactive aid to the user, the defined sections may be highlighted. The defined sections of data may be text; such as a phrase, a sentence, a paragraph or a whole page or more. The defined sections may also include images.

### TECHNICAL FIELD

The present invention relates to user interactive computer supported display technology and particularly to such user interactive word processing systems and methods that are user friendly and provide interactive users with a display interface environment that is easy to use.

### BACKGROUND OF RELATED ART

The past decade has been marked by a technological revolution driven by the convergence of the data processing industry with the consumer electronics industry. This advance has been even further accelerated by the extensive consumer and business involvement in the internet over the past few years. As a result of these changes, it seems as if virtually all aspects of human endeavor in the industrialized world requires human-computer interfaces. There is a need to make computer directed activities accessible to a substantial portion of the world's population which, up to a few years ago, was computer-illiterate or, at best, computer indifferent. In order for the vast computer supported market places to continue and be commercially productive, it will be necessary for a large segment of computer indifferent consumers to be involved in computer interfaces. There is one area where the computer controlled technology has made a tremendous advance in productivity: word processing, where reliable textual output has been increased ten-fold. However, the word processing technology continues to seek new expedients that are user friendly to further enhance the speed and reliability of this technology. The present invention offers such a novel expedient.

### SUMMARY OF THE PRESENT INVENTION

The present invention provides a user friendly display interface that expedites the switching of positions of a pair of sections with each other in a displayed document which is being edited. The invention involves means for defining one segment of displayed data in a displayed document together with means for defining another segment of displayed data in said displayed document and means enabling a user to select to swap said one segment with said another segment. There are means responsive to such a user selection to swap for swapping the positions of the defined segments of data with each other. As an interactive aid to the user, the defined sections may be highlighted. The defined sections of data may be text; such as a phrase, a sentence, a paragraph or a whole page or more. The defined sections may also include images. While the embodiment that follows illustrates the swapping in a word processing system, it will be clear that the system, method and programs described herein may be used for the swapping of data sections in other documents; such as spread sheets and other numerically arranged documents; computer program listings and documents; as well as documents that are primarily graphic in content.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system including a central processing unit that is capable of implementing the present invention of swapping sections in a document being edited;

FIG. 2 is a diagrammatic starting view of a display screen to illustrate the steps involved in the swapping of phrases of text;

FIG. 3 is the diagrammatic view of FIG. 2 after the sections of text have been swapped;

FIG. 4 is a diagrammatic starting view of a display screen like that of FIG. 2 to illustrate the steps involved in the swapping of paragraphs of text;

FIG. 5 is the diagrammatic view of FIG. 4 after the paragraphs of text have been swapped;

FIG. 6 is a general flowchart of a program set up to implement the present invention for swapping sections in a displayed document being edited; and

FIG. 7 is a flowchart of an illustrative run of a program set up in accordance with the flowchart of FIG. 6.

### DETAILED DESCRIPTION OF THE PREFERRED EMBODIMENT

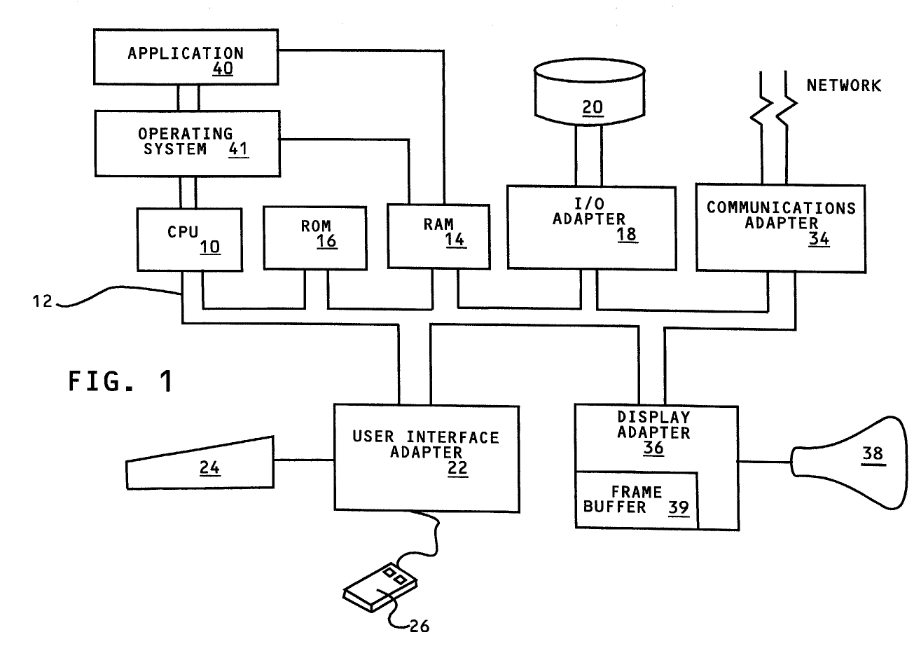

Referring to FIG. 1, a typical generalized data processing system display terminal is shown which may function as the computer controlled display terminal used for swapping sections in a document being edited. A central processing unit (CPU) 10, such as any PC microprocessor in a PC available from International Business Machines Corporation (IBM) or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's Windows98™ or WindowsNT™, as well as the UNIX or AIX operating systems. An application program that includes routines for defining and swapping sections in a displayed document, to be subsequently described in detail, runs in conjunction with operating system 41 and provides output calls to the operating system 41, which, in turn, implements the various functions to be performed by the application 40. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20, i.e. a hard drive. Communications adapter 34 interconnects bus 12 with an outside network enabling the data processing system to communicate with other such systems over a Local Area Network (LAN) or a Wide Area Network (WAN), which includes, of course, the Internet or World Wide Web (Web). I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned mouse or related devices, a user is capable of inputting information to the system through the keyboard 24 or mouse 26 and receiving output information from the system via display 38.

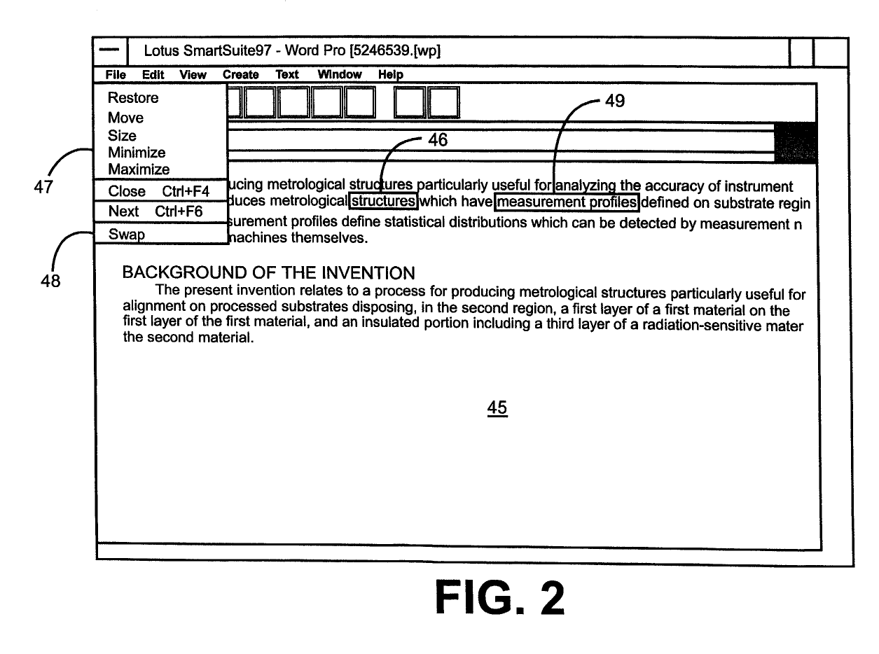

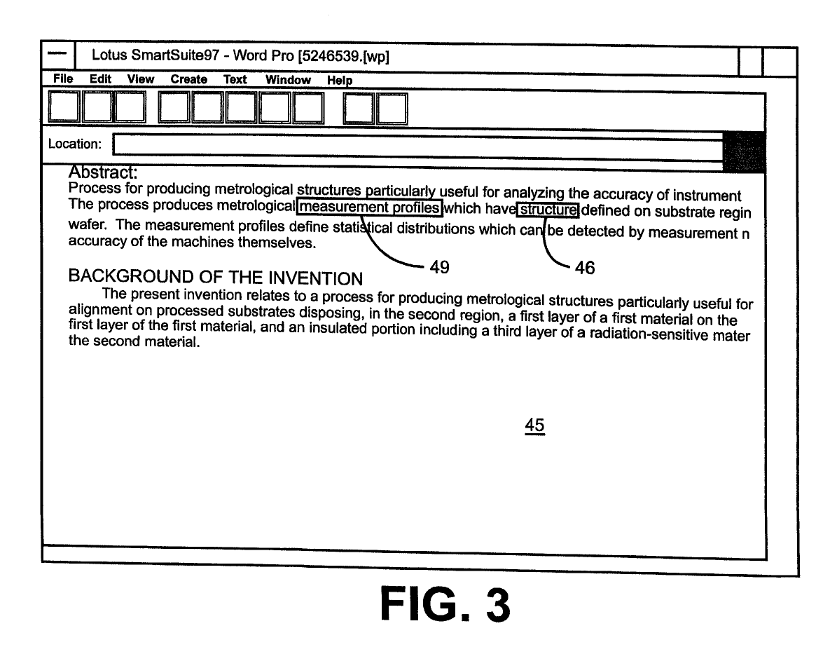

With reference to FIG. 2, the display screen 45 as shown has a displayed text document 45 at the stage where highlighted phrase 46 is ready to be swapped with highlighted phrase 49. The document could have reached this stage in several ways. One convenient approach, after the user decides which sections he wishes to swap, is for the user to first designate the section 46 that he wishes to switch. This may be done by any standard word processing technique for designating or blocking off a section in the document, such as highlighting. The user then finds the icon or item that designates the swap function in the display interface screen. In the present example, this is done by dropping down menu 47 which includes “SWAP” item 48. After the user clicks on and, thus, highlights item 48, he then designates section 49, e.g. by highlighting the other section in the swap. The user then completes the swap by an appropriate mouse click or keyboard “Enter” to effect the swap shown in FIG. 3, wherein phrases 49 and 46 have interchanged their respective positions in the displayed document. For convenience in ease of use of the interface, the swap routine may maintain the highlighting of the swapped sections for a brief period in the order of sections so that the user may check as to whether his change is appropriate.

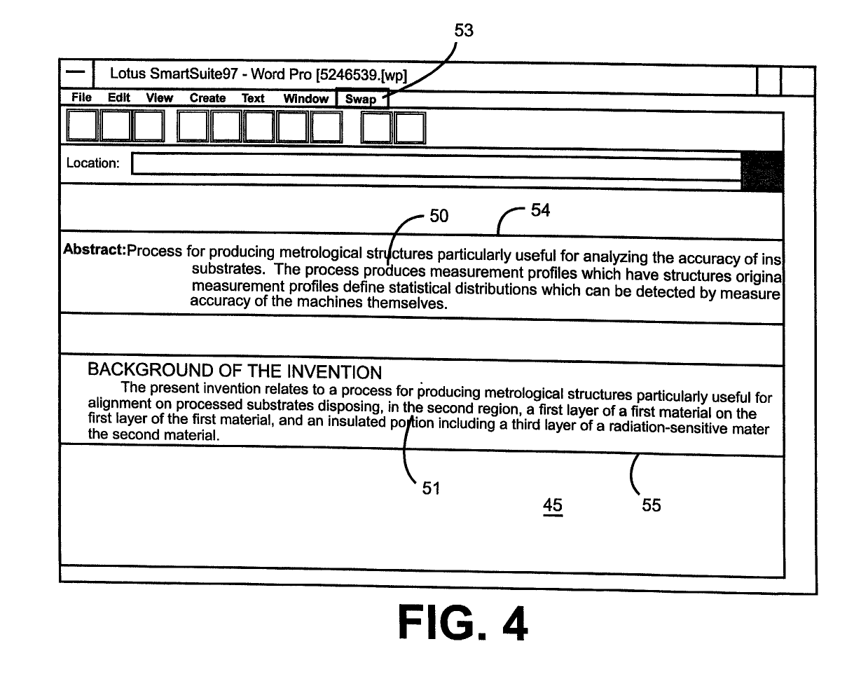

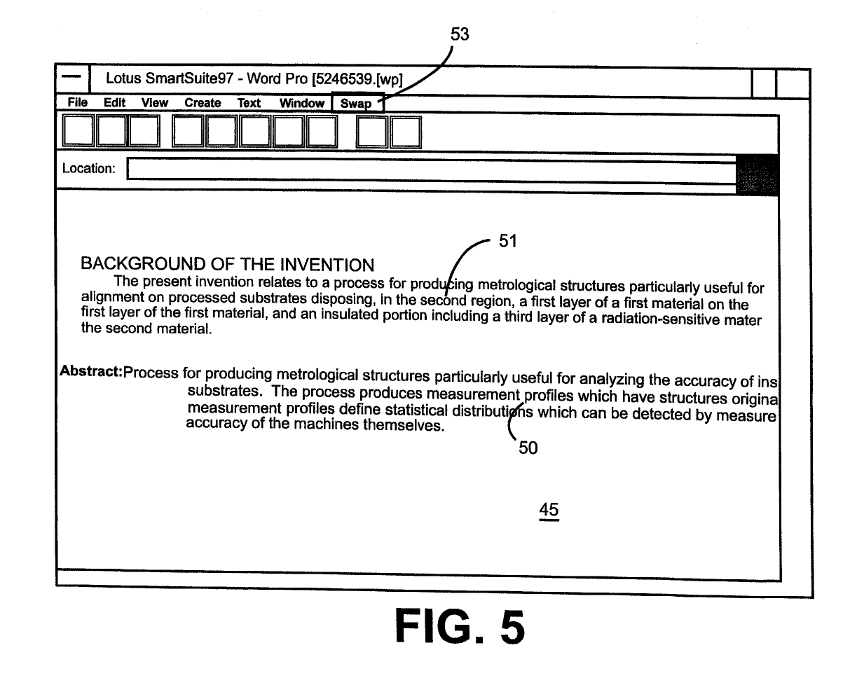

FIGS. 4 and 5 illustrate the swapping of document sections, i.e. paragraphs by a somewhat varied routine. In this example, the “SWAP” 53 is located in the title menu bar of the display. Here the swap may involve a simple routine:

Enable user to Select Swap;

Click-on Swap Item 53;

Request User to Designate 54 First Section 50;

Request User to Designate 55 Second Section 51;

Activate the Swap.

The result of the Swap is shown in FIG. 5 where paragraph 51 has swapped positions with paragraph 50.

It should be understood that the swap function of the present invention may be applied to the swapping of words, phrases, sentences, paragraphs, pages or even chapters in documents. Both alphanumeric text and images may be included in the swapped sections.

While the swap function of this invention is simple in its implementation, it is advantageous over other known routines in word processing for changing the positions of sections of data in word processing displays. It is submitted to be more user friendly and intuitive. Also, it eliminates steps over other word processing routines. For example, it is simpler than the routines for the “cut and paste” or “move” editing functions. In the latter, which is probably simplest, the user would have to designate, e.g. highlight the first section, use the move function to move it into the position of the second section and then similarly designate and move the second section into the position vacated by the moved first section.

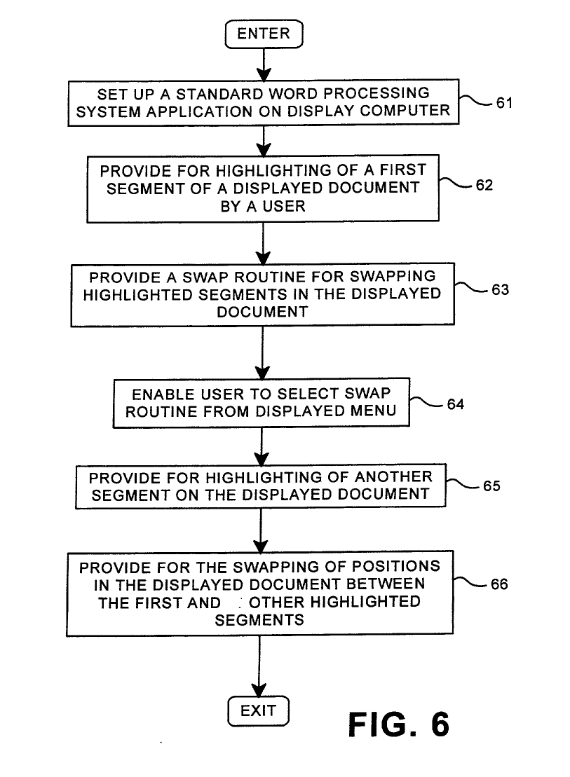

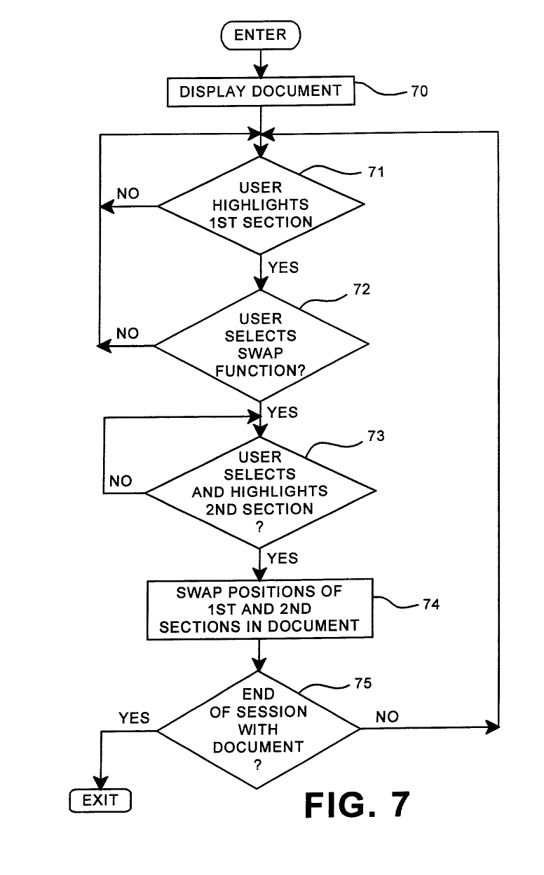

Now, with reference to FIGS. 6 and 7, we will describe a process implemented by the present invention in conjunction with the flowcharts of these figures. FIG. 6 is a flowchart showing the development of a process according to the present invention for swapping the positions of sections in a displayed document to be edited. A standard word processing operation is set up on a data processor controlled user interactive display interface, step 61. There is provision made for the highlighting and, thereby, the designation of a first section in a displayed word processing document, step 62. A routine is provided for swapping the positions of a pair of highlighted sections in the displayed document, step 63. The user is enabled to select the swap routine by clicking on an item or an icon in a displayed menu, step 64. The designating by highlighting of a second section of the displayed document is provided, step 65. Finally, there is provision for the swapping of the respective positions of the highlighted sections as activated by the user, step 66.

An illustrative run of the process set up in FIG. 6 will now be described with respect to FIG. 7. First, step 70, the document is displayed. A determination is then made as to whether the user has highlighted a section in the document, step 71. If No, the process is returned to step 71 to await highlighting. If Yes, a section is highlighted, then a further determination is made as to whether the user has selected the Swap function, step 72. If No, it is assumed that the section was highlighted for some other word processing function, and the process is branched back to step 71 where another highlighting of another section is awaited. If the determination from step 72 is Yes, the user has selected the Swap function, then a further determination is made as to whether the user has highlighted a second section, step 73. If No, then the process is returned to step 73 where such highlighting is awaited. If the determination in step 73 is Yes, the user has highlighted a second section, then upon a confirmatory mouse click or enter by the user, the positions of the first and second sections are switched, step 74. At this point, a determination, step 75, may conveniently be made as to whether the word processing session with the particular document is at an End. If Yes, the session is exited. If No, the process is branched back to step 71 where another highlighting of another section is awaited.

The following is a set of typical pseudocode statements for a Swap function.

Enable a user to highlight a 1st block of data;

User highlights a 1st displayed block;

Store 1st block;

Enable user to select “Swap”;

User selects Swap;

Prompt user to select 2nd block;

User selects 2nd block;

Store 2nd block;

User trigger, e.g. mouse click;

Swap displayed positions of the 1st and 2nd blocks.

One of the implementations of the present invention is as an application program 40 made up of programming steps or instructions resident in RAM 14, FIG. 1, during computer operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled user-interactive document editing display system comprising:
means for defining one segment of displayed data in a displayed document;
means for defining another segment of displayed data in said displayed document;
means enabling a user to select to swap said one segment with said another segment; and
means responsive to said user selection to swap for swapping the positions of said segments of data with each other.

2. The document editing display system of claim 1, further including means for highlighting said one and said another segments prior to swapping the positions of said segments.

3. The document editing display system of claim 1, wherein said displayed data in said swapped segments is alphanumeric text.

4. The document editing display system of claim 3, wherein said alphanumeric text in each of said swapped segments is a phrase.

5. The document editing display system of claim 3, wherein said alphanumeric text in each of said swapped segments is a sentence.

6. The document editing display system of claim 3, wherein said alphanumeric text in each of said swapped segments is a paragraph.

7. The document editing display system of claim 3, wherein said alphanumeric text in each of said swapped segments is at least one page in length.

8. The document editing display system of claim 3, wherein said swapped segments further include images.

9. A method of user-interactive document editing on a display comprising:
defining one segment of displayed data in a displayed document;
defining another segment of displayed data in said displayed document;
enabling a user to select to swap said one segment with said another segment; and
swapping the positions of said segments of data with each other responsive to a user selection to swap.

10. The document editing method of claim 9 further including the steps of highlighting said one and said another segments prior to swapping the positions of said segments.

11. The document editing method of claim 9, wherein said displayed data in said swapped segments is alphanumeric text.

12. The document editing method of claim 11, wherein said alphanumeric text in each of said swapped segments is a phrase.

13. The document editing method of claim 11, wherein said alphanumeric text in each of said swapped segments is a sentence.

14. The document editing method of claim 11, wherein said alphanumeric text in each of said swapped segments is a paragraph.

15. The document editing method of claim 11, wherein said alphanumeric text in each of said swapped segments is at least one page in length.

16. The document editing method of claim 11, wherein said swapped segments further include images.

17. A computer program having program code included on a computer readable medium for user-interactive document editing on a computer controlled display system comprising:
means for defining one segment of displayed data in a displayed document;
means for defining another segment of displayed data in said displayed document;
means enabling a user to select to swap said one segment with said another segment; and
means responsive to said user selection to swap for swapping the positions of said segments of data with each other.

18. The computer program of claim 17, further including means for highlighting said one and said another segments prior to swapping the positions of said segments.

19. The computer program of claim 18, wherein said displayed data in said swapped segments is alphanumeric text.

20. The computer program of claim 19, wherein said alphanumeric text in each of said swapped segments is a phrase.

21. The computer program of claim 19, wherein said alphanumeric text in each of said swapped segments is a sentence.

22. The commuter program of claim 19, wherein said alphanumeric text in each of said swapped segments is a paragraph.

23. The computer program of claim 19, wherein said alphanumeric text in each of said swapped segments is at least one page in length.

24. The computer program of claim 19, wherein said swapped segments further include images.
